(19) United States
(12) Patent Application Publication
(10) Pub. No.: US 2018/0225666 A1
(43) Pub. Date: Aug. 9, 2018

(54) METHODS AND SYSTEMS FOR PROVIDING AN ENTITY WITH THE ABILITY TO CONTROL BEHAVIORS AND CAPABILITIES OF THE ENTITY'S ACCOUNTS AND/OR ACCOUNT TRANSACTIONS ON A PER-USER BASIS

(71) Applicant: Omnyway, Inc., Redwood City, CA (US)

(72) Inventors: Mohammad KHAN, San Jose, CA (US); William N. MELTON, San Francisco, CA (US); Ashok NARASIMHAN, San Francisco, CA (US)

(73) Assignee: Omnyway ,Inc., Redwood City ,, CA (US)

(21) Appl. No.: 15/750,762

(22) PCT Filed: Jul. 29, 2016
(86) PCT No.: PCT/US2016/044725

§ 371 Date: Feb. 6, 2018

Related U.S. Application Data
(60) Provisional application No. 62/202,064, filed on Aug. 6, 2015.

(51) Int. Cl. G06Q 20/40; G06Q 20/22

(52) U.S. Cl. CPC G06Q 20/405; G06Q 20/12; G06Q 20/223

(57) ABSTRACT

According to one aspect, the subject matter described herein includes a system for providing an entity with the ability to control behaviors and capabilities of accounts of the entity on a per-user basis. The system includes a database for associating the entity with at least one account and for storing entity-defined and user-defined preferences that control behaviors and capabilities of the entity's accounts and/or account transactions on a per-user basis. The system also includes a mobile backend server that operates as a conduit or intermediary for electronic financial or non-financial transactions of the entity and that applies to the transactions the preferences that control behaviors and capabilities of the entity's accounts on a per-user basis prior to processing by a payment transaction network.

### RELATED APPLICATIONS

This application claims the benefit of U.S. Provisional Patent Application Ser. No. 62/202,064, filed Aug. 6, 2015, the disclosure of which is hereby incorporated herein by reference in its entirety.

### TECHNICAL FIELD

This disclosure relates to performing and managing financial and non-financial electronic transactions made by consumers. More specifically, it relates to methods and systems for providing an entity with the ability to control behaviors and capabilities of the entity's accounts and/or account transactions on a per-user basis.

### BACKGROUND

Consumers now have access to a variety of different types of payment or non-payment instruments, herein collectively referred to as “transaction instruments”. Examples of payment instruments include credit cards, debit cards, prepaid cards, etc. Examples of non-payment instruments include loyalty cards, membership cards, and rewards programs. A typical consumer may possess one or more credit cards, one or more debit cards, prepaid cards, other payment accounts (e.g., ACH account) and one or more loyalty/membership/rewards cards on a smartphone for personal use. Furthermore, the consumer may allow use of one or more of these instruments by a spouse's smartphone, childrens' smartphones, or employees' smartphones for personal use, but with certain desired controls. For example, a parent may desire to provide a child with a credit card, debit card, prepaid card, etc., for use by the child only for certain purchases, only in certain circumstances or conditions, only in certain locations, and so on.

In another example, an employer may want to provide to an employee a payment instrument that may be used only for the purchase of office supplies or to make travel arrangements such as booking hotels, flights, and rental cars. In other examples, a person controlling or administering a payment card may desire to impose limits on the transaction amount, such as a per-transaction limit, a per-day limit, a per-week limit, a limit per some other unit of time, a cumulative limit over the lifetime of the card, etc. An office administrator, for example, may desire to allow multiple employees to use the same payment account; in this scenario, the administrator may desire to limit the total aggregated amount available to all card users collectively, with or without enforcing a limit on each user individually.

With the increase in smart phone ownership, a number of applications have appeared that allow a consumer to store information for multiple transaction instruments on a smart phone, but these applications are best described as “electronic wallets” that behave the same as a physical wallet, i.e., they store virtual credit/debit/loyalty cards—albeit in an electronic, rather than physical, form—and allow the user to select one for presentation to a point of sale terminal at the time of a financial transaction.

Although the currently available applications simplify the task of managing the ownership, possession, and use of all of these different transaction instruments, none allows the user to define specific behaviors and capabilities for specific financial accounts, much less allow the user to define alternative behaviors or capabilities under particular circumstances. To give some simple examples, a consumer may desire to use one credit card exclusively for online purchases and another for purchases in a physical store; to use a business credit card when purchasing office supplies and a personal credit or debit card when purchasing groceries; to use a credit card from one bank when making purchases larger than some threshold amount and a credit card from another bank for smaller purchases; and so on. Conventional payment systems do not have this user definable capability.

Accordingly, in light of the above-mentioned disadvantages, there is a need for methods and systems providing an entity with the ability to control behaviors and capabilities of the entity's accounts and/or account transactions on a per-user basis.

### SUMMARY

The subject matter disclosed herein includes methods and systems for providing an entity with the ability to control behaviors and capabilities of accounts and/or account transactions of the entity on a per-user basis. This type of behavior control service can be offered to users by their banks, retailers, and other payment or non-payment service providers. For example, an account owner may define rules that dictate how accounts or subaccounts may be used by different users or classes of users, such as family members, employees, etc.

According to one aspect, the subject matter described herein includes a system for providing an entity with the ability to control behaviors and capabilities of the entity's accounts and/or account transactions on a per-user basis. The system includes a database for associating an entity with at least one account and for storing entity-defined and user-defined preferences that control behaviors and capabilities of the entity's accounts and/or account transactions on a per-user basis. The system also includes a mobile backend server that operates as a conduit or intermediary for electronic financial or non-financial transactions of the user and that applies to the transactions the preferences that control behaviors and capabilities of the entity's accounts and/or account transactions on a per-user basis.

According to another aspect, the subject matter described herein includes a method for providing users with the ability to control behaviors and capabilities of the entity's accounts and/or account transactions on a per-user basis. The method includes: associating an entity with transaction or account information and storing entity-defined and user-defined preferences that control behaviors and capabilities of the entity's accounts and/or account transactions on a per-user basis; and providing a mobile backend server that operates as a conduit or intermediary for a user's electronic financial or non-financial transactions and that applies to the transactions the preferences that control behaviors and capabilities of the entity's accounts and/or account transactions on a per-user basis.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

As used herein, the term “user” refers to someone who uses a payment card or other payment instrument associated with an account to perform a transaction, whether or not they have the ability or permission level to control behaviors and capabilities of the entity's accounts and/or account transactions.

As used herein, the term “limited user” refers to a user whose ability to use a payment card or other payment instrument associated with an account to perform a transaction has been limited or restricted, sometimes drastically so. A limited user typically has little to no ability to define or change the behaviors and capabilities of the entity's accounts and/or account transactions.

As used herein, the term “privileged user” refers to a user who can control behaviors and capabilities of the entity's accounts and/or account transactions for themselves but not for other users, and whose settings can be overridden by an administrator. For example, a privileged user may set, modify, or delete limits, rules, and behaviors (collectively referred to as “rules”) that apply only to himself or herself.

As used herein, the term “administrator” (or “admin” for short) refers to someone who can control behaviors and capabilities of the entity's accounts and/or account transactions on a per-user basis. For example, an admin may set, modify, or delete limits, rules, and behaviors (collectively referred to as “rules”). According to one aspect, a “limited admin” can set rules for other users of the same or lower permission level, and a “full admin” (or just “admin”) can set rules for any and all users regardless of the users' permission level. A full admin may supplement or override settings by a limited admin. An administrator may or may not be a user. For example, a business entity may have an admin who sets rules but who never actually uses the company card.

As used herein, the term “owner” refers to a person or business entity whose name is on the card/account. The owner may or may not be an administrator and may or may not be a user. For example, for a personal card, the owner is probably the same as the administrator and is probably also a user. For a corporate account, however, the owner may be the corporate entity (and may not be a user) while the administrator may be the Chief Financial Officer (CFO) or other individual.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for providing an entity with the ability to control behaviors and capabilities of the entity's accounts and/or account transactions on a per-user basis according to an embodiment of the subject matter described herein;

FIG. 2 is a flow chart illustrating an exemplary process for providing an entity with the ability to control behaviors and capabilities of the entity's accounts and/or account transactions on a per-user basis according to an embodiment of the subject matter described herein;

FIGS. 3A and 3B are signaling messaging diagrams illustrating messages communicated among components of an exemplary system for providing an entity with the ability to control behaviors and capabilities of the entity's accounts and/or account transactions on a per-user basis according to an embodiment of the subject matter described herein; and

FIG. 4 is a signaling messaging diagram illustrating messages communicated among components of an exemplary system for providing an entity with the ability to control behaviors and capabilities of the entity's accounts and/or account transactions on a per-user basis according to an embodiment of the subject matter described herein.

### DETAILED DESCRIPTION

Methods and systems for providing an entity with the ability to control behaviors and capabilities of the entity's accounts and/or account transactions on a per-user basis are provided herein.

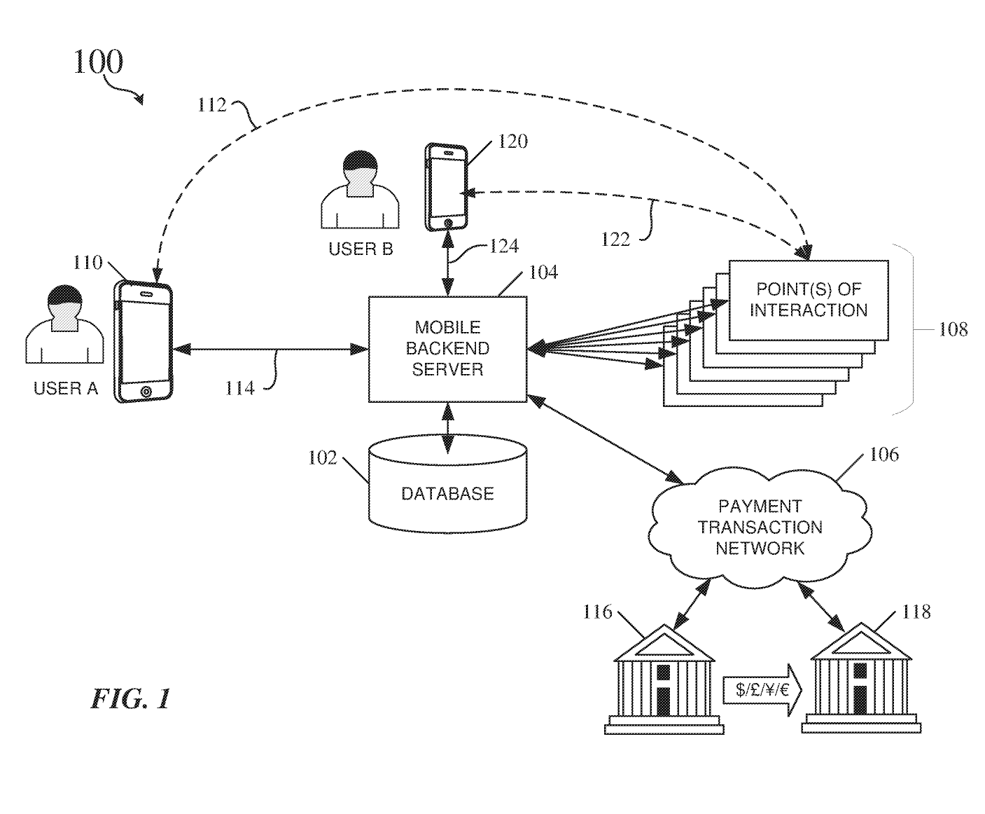

FIG. 1 is a block diagram illustrating an exemplary system providing an entity with the ability to control behaviors and capabilities of the entity's accounts and/or account transactions on a per-user basis according to an embodiment of the subject matter described herein. In the embodiment illustrated in FIG. 1, a system 100 includes a database 102 for associating a user with transaction information and/or account information and for storing entity-defined and/or user-defined preferences that control behaviors and capabilities of the entity's accounts and/or account transactions on a per-user basis, and a mobile backend server 104 that operates as a conduit or intermediary for the entity's electronic financial or non-financial transactions and that applies to the transactions the preferences that control behaviors and capabilities of the entity's accounts and/or account transactions on a per-user basis prior to processing by a payment transaction network 106.

Examples of transaction or account information include, but are not limited to, an account name, an account number, an account issuing bank, a user name, a user physical address, a user shipping address, identification information for identifying a user, and authentication information for authenticating a user.

In the embodiment illustrated in FIG. 1, mobile backend server 104 receives information associated with a desired transaction, which may be, for example, a request for a transaction, a notification of a transaction, etc., from or involving a variety of different points of interaction 108.

Examples of a transaction of the user include, but are not limited to, a payment or purchase; a credit transaction; a debit transaction; a prepaid transaction; a deposit; a withdrawal; a money transfer; bill payment; a transaction involving a loyalty program; a transaction involving a rewards program; or a transaction involving a diet, health, or fitness program.

To effect a transaction, a user may use a transaction instrument, which may be a payment instrument or a non-payment instrument. Examples of payment instruments include, but are not limited to, credit cards, debit cards, prepaid cards, checking, savings, or automatic clearing house (ACH) accounts, where payment cards or accounts could be issued by bank or non-bank (e.g., retailer) organizations. Examples of non-payment instruments include, but are not limited to, loyalty cards, coupons, offers, promotions, rewards, membership cards, healthcare cards, sports/entertainment events or season tickets, and passes.

Examples of points of interaction 108 include, but are not limited to, a physical point of sale terminal (POS), an ecommerce website, a kiosk, a business entity that charges a recurring fee, and so on.

For the purpose of illustration only, the information associated with a desired transaction will be hereinafter assumed to be a request for a transaction. In one embodiment, the transaction request may include information about the transaction, such as the transaction type, transaction amount (e.g., for financial transactions), information about the merchant, such as the merchant's identity, merchant class, information about the goods or services involved, or other information.

In one embodiment, in response to receiving the request for a transaction, mobile backend server 104 determines a user associated with the desired transaction, and uses that user identity to query database 102 to find a user account associated with the user. If an account if found, mobile backend server 104 may then query database 102 to determine entity-defined preferences and/or user-defined preferences for the desired transaction, for the user account, or both. Mobile backend server 104 may then apply the preference(s) to modify a behavior or capability of the desired transaction, user account, or both.

In the embodiment illustrated in FIG. 1, mobile backend server 104 may interact with a mobile device 110 associated with a particular user, “User A”. Mobile device 110 may be used to provide the user information, such as user account information and entity-defined or user-defined preference information, that is stored in database 102 for use by mobile backend server 104 to modify the behavior or capability of the transaction or account. For example, a user may use an application that is hosted by mobile device 110 and that is designed to allow the user to securely connect to mobile backend server 104 for the purpose of registering mobile device 110 to a particular user, creating or updating user account information, specifying entity-defined or user-defined preferences, and setting up preferences, rules, and conditions that should be applied to the transactions.

Likewise, mobile device 110 may be a party to a transaction and/or may communicate with one of the points of interaction 108. For example, a user that is shopping on an ecommerce website—either on mobile device 110 or on another device, such as a personal computer, for example—may use mobile device 110 to handle the actual ecommerce transaction in a secure manner, such as in a manner disclosed in commonly-owned U.S. patent application Ser. No. 15/093,694, filed Apr. 7, 2016, and Ser. No. 15/154,591, filed May 13, 2016, both of which are incorporated herein by reference in their entireties.

In one example, a user who is shopping on an ecommerce site 108 and desires to start the checkout process to complete the purchase may select a “pay now” option displayed on the ecommerce site. In one embodiment, a quick response (QR) code that includes information about the transaction (or information that may be used to retrieve information about the transaction) may be displayed on the ecommerce website checkout screen, which the user scans using mobile device 110 (information transfer 112). Mobile device 110 then may decode the QR code and send the decoded information to mobile backend server 104 (communication 114). Mobile backend server 104 may then query database 102 to get entity-defined or user-defined preferences and rules that may determine whether the desired transaction will be allowed or not allowed, whether a notification or alert will be sent or not sent, or other specific behaviors and capabilities for specific transactions and/or accounts as defined by the user.

If the transaction is allowed, mobile backend server 104 may then query database 102 to retrieve the pertinent account information and use that information to perform or initiate the desired transaction. Examples of an account of the user include, but are not limited to, a card payment account or a non-card, cardless, or virtual card account, a payment account; a credit, debit, or prepaid account; a branded account; a retailer or private label account; a gift or gift card account; a checking or savings account; a loyalty account; a healthcare or wellness account; an access account; a membership account; or a rewards account.

In another example, a user may desire to use mobile device 110 to perform or complete a secure financial transaction at a physical store, in which case point of interaction 108 may be a POS terminal. In this scenario, information transfer 112 may be via a QR code as described above, but also may be via near field communication (NFC), Bluetooth, WiFi, or other wireless communication with the POS terminal, by the user's manual entry into mobile device 110 information that is provided by the merchant, and so on.

Likewise, mobile device 110 may be used to provide secure authentication of the user/account owner, such as via the use of passwords, passcodes, personal identification numbers (PINs), biometrics, social networking, physical location, etc. In this scenario, authentication information (or proof of successful authentication) may be conveyed to mobile backend server 104 via communication 114.

Where the desired transaction is a financial transaction, in one embodiment, mobile backend server 104 may determine, based on the application of the user-defined rules, that the transaction is allowed. In this scenario, mobile backend server 104 may then retrieve confidential information, such as payment details, from database 102 and send that information to the payment transaction network 106, which handles the transfer of funds from the user's account in a bank 116 to the merchant's account in another bank 118, for example. Other examples will be described in detail, below.

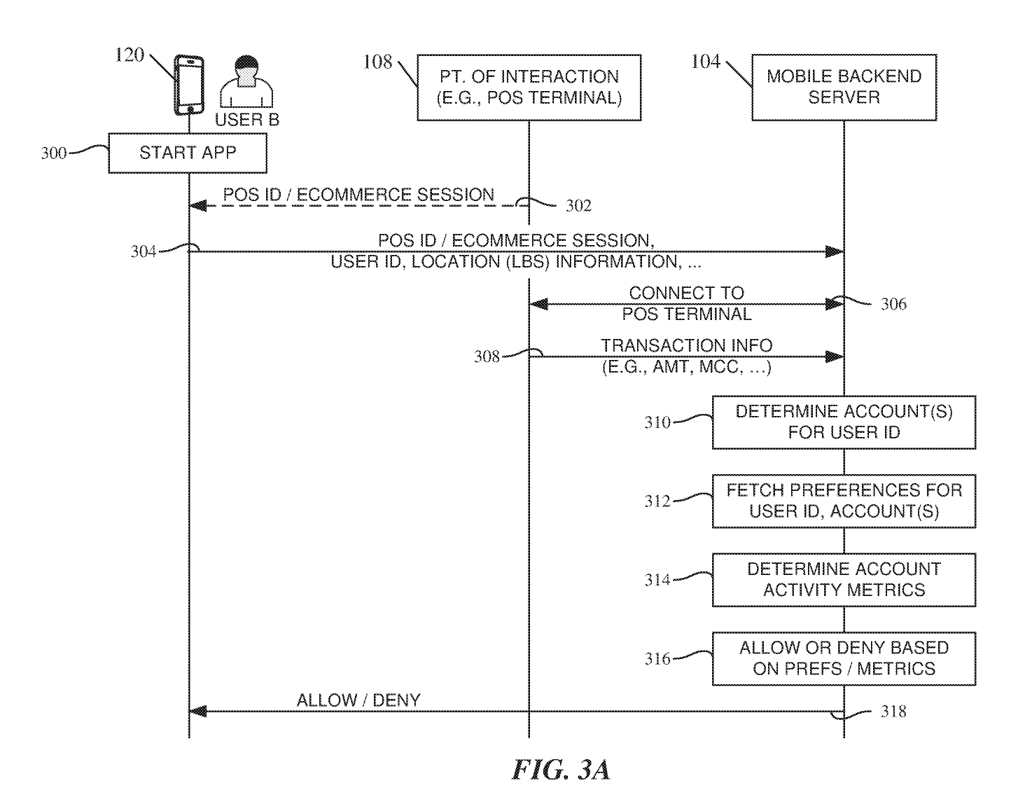

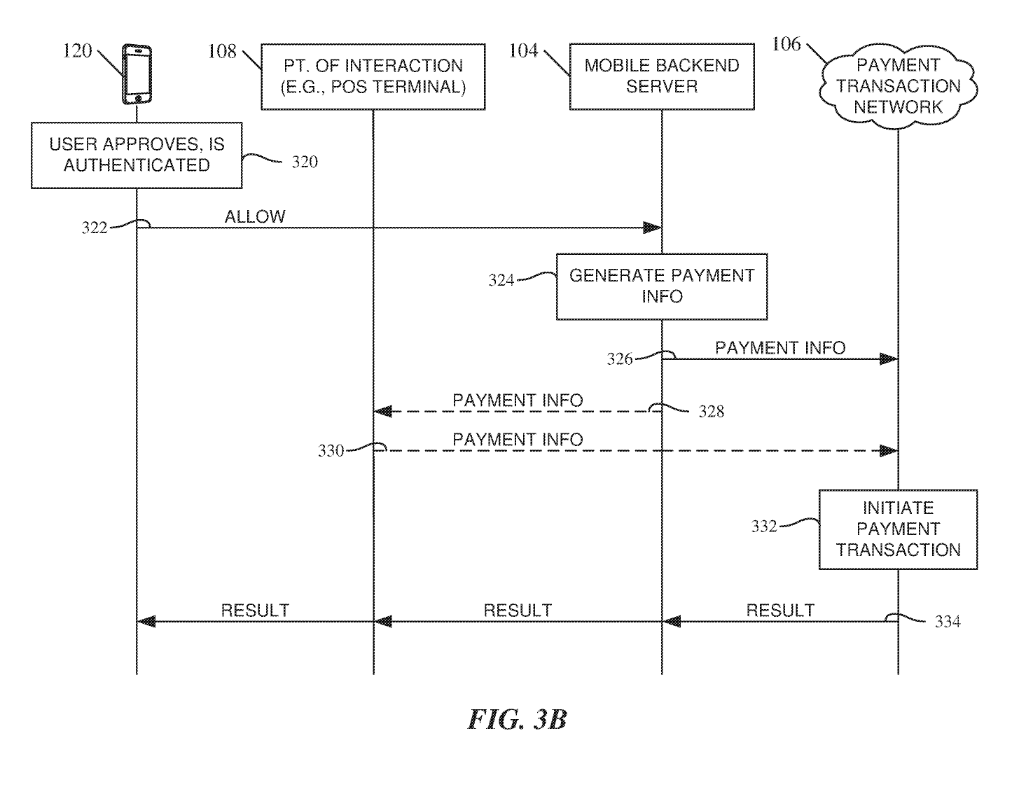

FIG. 1 also shows a second mobile device 120, which is used by a second user, “User B”. For the purpose of illustration, it will be assumed that User B is a user with limited administrative rights, e.g., a “limited user”, but the same principles of operation apply regardless of the user type. User B may likewise communicate with a point of interaction 108 (message 122) and/or mobile backend server 104 (message 124). An example of activity involving User B will be described in more detail in FIGS. 3A and 3B, below.

Examples of the information associated with the desired transaction include, but are not limited to, information about a type of the transaction, an amount of the transaction, a party to the transaction, a time of the transaction, a location of the transaction, and a good, service, or subject of the transaction.

In one embodiment, the mobile backend server 104 receives the information associated with a desired transaction from a mobile device of the user.

In one embodiment, the mobile device of the user may receive the information associated with the desired transaction from a user of the mobile device, a point of sale terminal, an ecommerce website, or the mobile backend server.

In one embodiment, the mobile device of the user receives the information associated with the desired transaction via scanning and decoding QR code that encodes at least some of the information.

In one embodiment, the mobile device of the user receives the information associated with the desired transaction via NFC.

Examples of transactions include, but are not limited to, transactions made using a physical point of sale terminal, transactions made online or via an ecommerce website, and transactions made using a mobile device or mobile application.

In one embodiment, the entity-defined or user-defined preferences that control behaviors and capabilities of the entity's accounts and/or account transactions on a per-user basis may include a preference related to an account.

Examples of a preference related to an account include, but are not limited to: an active/enabled or inactive/disabled state of the account; a restriction on use of the account involving a user or class of users; a restriction on use of the account involving a merchant or class of merchants; a restriction on a transaction involving an ecommerce site or class of ecommerce sites; a restriction on a transaction involving a point of sale terminal or class of point of sale terminals; a restriction on use of the account for a good or class of goods; a restriction on use of the account for a service or class of services; a temporal restriction on use of the account; a geographical restriction on use of the account; a restriction on a class of accounts; a restriction on an amount or range of amounts allowed per transaction; a restriction on an amount or range of amounts allowed per a period of time; a restriction on a type of device used to perform the transaction; an ability to transfer funds to or from the account; an ability to transfer control of the account; an ability to create a sub-account; an ability of the account to be shared by multiple users; and any combination of the above.

In one embodiment, the entity-defined or user-defined preferences that control behaviors and capabilities of the entity's accounts and/or account transactions on a per-user basis may include a preference related to a transaction.

Examples of a preference related to a transaction include, but are not limited to: a restriction on a type of transaction; a restriction on a transaction involving a user or class of users; a restriction on a transaction involving a merchant or class of merchants; a restriction on a transaction involving an ecommerce site or class of ecommerce sites; a restriction on a transaction involving a point of sale terminal or class of point of sale terminals; a restriction on a transaction for a good or class of goods; a restriction on a transaction for a service or class of services; a temporal restriction on transactions; a geographical restriction on transactions; a restriction on a transaction for an amount limit or range of amounts; a restriction on a type of device used to perform the transaction; a restriction on a transaction's recurrence; and any combination of the above.

In one embodiment, the entity-defined or user-defined preferences that control behaviors and capabilities of the entity's accounts and/or account transactions on a per-user basis may include an application of a entity-defined or user-defined preference.

Examples of application of a entity-defined or user-defined preference include, but are not limited to: imposition of a user's favored preference, prohibition of a user's disfavored preference, selection of a user's most favored preference of those available for a particular transaction, and selection of a user's most favored preference of those available for a particular account.

Examples of a entity-defined or user-defined preference include, but are not limited to, a shipping preference, a level or type of authentication to be required for the transaction or account, a level of type authorization to be required for the transaction or account, and a level of type notification of the occurrence of a transaction or account.

In one embodiment, the entity-defined or user-defined preferences that control behaviors and capabilities of the entity's accounts and/or account transactions on a per-user basis may include a preference related to a condition.

Examples of a preference related to a condition include, but are not limited to, a preference related to a condition of the transaction, a preference related to a condition of the account, a preference related to a condition of the user, or any combination of the above.

In one embodiment, a user or other entity with administrative privileges can control behaviors and capabilities of the entity's accounts or account transactions as applied to another user. In the example illustrated in FIG. 1, a first user, “User A”, with admin privileges defines rules and limits that apply to a second user, “User B”, who has access to an account or sub-account controlled by User A. When User B attempts to perform a transaction, e.g., by using the mobile device 120 or by using a credit card, debit card, or other payment instrument at the point of interaction 108, the attempted transaction will be routed through mobile backend server 104 (or mobile backend server 104 will otherwise be involved in an interaction with the point of interaction 108). Mobile backend server 104 will determine the identity of User B, query database 102 to determine whether any rules or limits apply to User B, and if, so, apply those rules or limits to control the behavior and capability of the account or transaction available to User B. The rules or limits that are applied to User B may be unique to User B or otherwise different from the rules or limits that are applied to User A or another user.

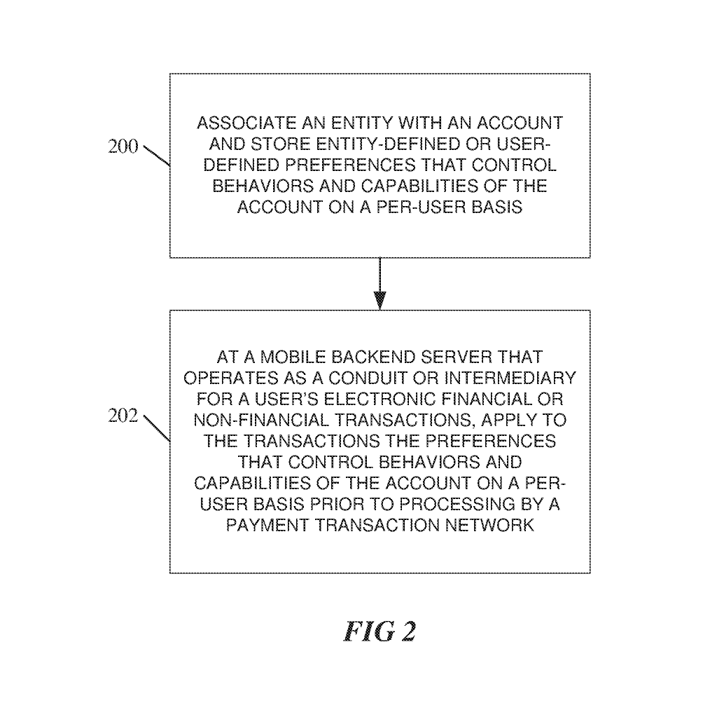

FIG. 2 is a flow chart illustrating an exemplary process for providing an entity with the ability to control behaviors and capabilities of the entity's accounts and/or account transactions on a per-user basis according to an embodiment of the subject matter described herein. In the embodiment illustrated in FIG. 2, the method includes:

At step 200, associating a user with transaction or account information and storing entity-defined or user-defined preferences that control behaviors and capabilities of the entity's accounts and/or account transactions on a per-user basis. In the embodiment illustrated in FIG. 1, for example, User B may be associated with a particular credit card or bank account, and User B's use of that credit card or bank account may be controlled or otherwise limited by preferences defined by User A. This scenario is useful to allow a parent (User A) to define what a child (User B) can and cannot do with a credit card issued to that child. This functionality may likewise be used by an employer to control the use of a company credit card by an employee. Because the preferences are defined on a per-user basis, they may be applied independently of the particular instrument used. For example, a parent may restrict a child's financial activity regardless of whether the child uses a credit card, a debit card, a pre-paid card, an electronic payment instrument, and so on. The parent may set consolidated limits (e.g., total spending limits for all instruments combined) as well as per-instrument limits (e.g., separate spending limits for a credit card versus for a debit card).

Continuing the parent/child paradigm, the spending limits that a parent may impose upon a child may be implemented in a number of ways. For example, a parent may create a spending limit by moving a fixed amount of funds into a child's separate financial instrument and/or account, such as a prepaid card for exclusive use by a child (or for shared use by multiple children). In this scenario, the child's money is financially separate from the parent's money, e.g., in separate bank accounts or other financial instruments such as prepaid cards. Alternatively, a parent may create a spending limit by limiting the child's ability to access money in the parent's bank account. In this scenario, there is no actual separation of parent's money from child's money: instead, the child is allowed to access only a defined amount of the parent's funds, e.g., when using a debit card, and/or to use only a defined amount of the parent's available credit, e.g., when using a credit card. Other mechanisms to impose constraints on a child's accounts and/or transactions are contemplated by the subject matter described herein.

In yet another scenario, a user (e.g., User A in FIG. 1) may set up rules and limits for himself or herself, e.g., for the purpose of defining a personal or household budget. In one embodiment, if User A attempts to make a purchase for a category of goods that exceeds a budget limit—e.g., User A spends more money eating at restaurants than the budget allows—the system may deny that transaction. In another embodiment, such a transaction may be allowed, but User A or another user or administrator may be notified that the budget limit for that category has been exceeded. In yet another embodiment, the transaction is allowed, and User A is notified of the overage and requested or required to select funds from another budget category to cover the difference, thus highlighting the consequences of failing to follow the budget plan, i.e., that going over budget in one category results in a curtailment of spending in another category or categories in order to meet budget goals. Similarly, an employer may set up budgets for individuals (e.g., employees, contractors, consultants, etc.), for groups of individuals, or combinations of the above.

At step 202, providing a mobile backend server that operates as a conduit or intermediary for a user's electronic financial or non-financial transactions and that applies to the transactions the preferences that control behaviors and capabilities of the entity's accounts and/or account transactions on a per-user basis prior to processing by a payment transaction network. Because the preferences that control behaviors and capabilities are applied prior to processing by a payment transaction network, the concepts and principles described herein can be provided without requiring any change to existing payment transaction networks.

Examples of the transaction or account information include, but are not limited to, an account name, an account number, an account issuing bank, a user name, a user physical address, a user shipping address, identification information for identifying a user, and authentication information for authenticating a user.

Examples of a transaction of the user include, but are not limited to, a payment or purchase, a credit transaction, a debit transaction, a deposit, a withdrawal, a money transfer, a transaction involving a loyalty program, a transaction involving a rewards program, and a transaction involving a diet, health, or fitness program.

Examples of an account of the user include, but are not limited to, a card payment account, and a non-card, cardless, or virtual card account.

Examples of an account of the user include, but are not limited to, a payment account, a credit, debit, or prepaid account, a branded account, a retailer or private label account, or a gift or gift card account.

Examples of an account of the user include, but are not limited to, a loyalty account, a healthcare or wellness account, an access account, a membership account, or a rewards account.

In one embodiment, applying user-defined preferences to the user's transactions includes receiving information associated with a desired transaction, determining a user associated with the desired transaction, determining a user account associated with the user, determining a user-defined preference for the desired transaction, for the user account, or both, and applying the user-defined preference to modify a behavior or capability of the desired transaction, user account, or both.

Examples of the information associated with the desired transaction include, but are not limited to, a type of the transaction, an amount of the transaction, a party to the transaction, a time of the transaction, a location of the transaction, and a good, service, or subject of the transaction.

In one embodiment, the mobile backend server receives the information associated with a desired transaction from a mobile device of the user. The mobile device of the user may have received the information associated with the desired transaction from a user of the mobile device, a point of sale terminal, an ecommerce website, or the mobile backend server.

In one embodiment, the mobile device of the user receives the information associated with the desired transaction via scanning and decoding a QR code that encodes at least some of the information.

In one embodiment, the mobile device of the user receives the information associated with the desired transaction via NFC.

Examples of the transactions include, but are not limited to, transactions made using a physical point of sale terminal, transactions made online or via an ecommerce website, and transactions made using a mobile device or mobile application.

In one embodiment, the entity-defined or user-defined preferences that control behaviors and capabilities of the entity's accounts and/or account transactions on a per-user basis may include a preference related to an account.

Examples of a preference related to an account include, but are not limited to: an active/enabled or inactive/disabled state of the account, a restriction on use of the account involving a user or class of users, a restriction on use of the account involving a merchant or class of merchants, a restriction on a transaction involving an ecommerce site or class of ecommerce sites, a restriction on a transaction involving a point of sale terminal or class of point of sale terminals, a restriction on use of the account for a good or class of goods, a restriction on use of the account for a service or class of services, a temporal restriction on use of the account, a geographical restriction on use of the account, a restriction on a class of accounts, a restriction on an amount or range of amounts allowed per transaction, a restriction on an amount or range of amounts allowed per a period of time, a restriction on a type of device used to perform the transaction, an ability to transfer funds to or from the account, an ability to transfer control of the account, an ability to create a sub-account, an ability of the account to be shared by multiple users, and any combination of the above.

In one embodiment, the entity-defined or user-defined preferences that control behaviors and capabilities of the entity's accounts and/or account transactions on a per-user basis may include a preference related to a transaction.

Examples of a preference related to a transaction include, but are not limited to: a restriction on a type of transaction, a restriction on a transaction involving a user or class of users, a restriction on a transaction involving a merchant or class of merchants, a restriction on a transaction involving an ecommerce site or class of ecommerce sites, a restriction on a transaction involving a point of sale terminal or class of point of sale terminals, a restriction on a transaction for a good or class of goods, a restriction on a transaction for a service or class of services, a temporal restriction on transactions, a geographical restriction on transactions, a restriction on a transaction for an amount limit or range of amounts, a restriction on a type of device used to perform the transaction, a restriction on a transaction's recurrence, and any combination of the above.

In one embodiment, the entity-defined or user-defined preferences that control behaviors and capabilities of the entity's accounts and/or account transactions on a per-user basis may include an application of a entity-defined or user-defined preference.

Examples of application of a entity-defined or user-defined preference include, but are not limited to: imposition of a user's favored preference, prohibition of a user's disfavored preference, selection of a user's most favored preference of those available for a particular transaction, and selection of a user's most favored preference of those available for a particular account.

Examples of a entity-defined or user-defined preference include, but are not limited to: a shipping preference, a level or type of authentication to be required for the transaction or account, a level of type authorization to be required for the transaction or account, and a level of type notification of the occurrence of a transaction or account.

In one embodiment, the entity-defined or user-defined preferences that control behaviors and capabilities of the entity's accounts and/or account transactions on a per-user basis may include a preference related to a condition.

Examples of a preference related to a condition include, but are not limited to, a preference related to a condition of the transaction, a preference related to a condition of the account, a preference related to a condition of the user, or any combination of the above.

FIG. 3A is a signaling messaging diagram illustrating messages communicated among components of an exemplary system for providing an entity with the ability to control behaviors and capabilities of the entity's accounts and/or account transactions on a per-user basis according to an embodiment of the subject matter described herein.

The process may start at the time of any transaction. In the embodiment illustrated in FIG. 3A, the process is triggered by an attempt, by a user (“User B”) to use a smartphone or other mobile device 120 to perform an electronic transaction, but the process may be triggered by other types of transactions, including but not limited to, an attempt by a user to use a provided credit or debit card, for example.

In the embodiment illustrated in FIG. 3A, at step 300, User B may start a payment application (or other type of application) on his mobile device 120 which will effect the transaction. In the embodiment illustrated in FIG. 3A, the application allows mobile device 120 to receive information from point of interaction 108 (message 302). Examples of this information include, but are not limited to, information that identifies a POS terminal that is involved with the transaction (e.g., the POS ID), information that identifies an ecommerce session, and so on.

This information may be conveyed to mobile device 120 in any manner. In one embodiment, for example, point of interaction 108 may encode the information as a QR code, bar code, text, or other visual display, which is scanned/viewed/recorded by a camera or other visual sensor of mobile device 120 and decoded to extract the information. In another embodiment, the information may be transmitted as a sound file or other audio format, which is picked up/recorded by a microphone or other audio sensor of mobile device 120 and decoded to extract the information. In yet another embodiment, the information may be transmitted via wired or wireless communication between point of interaction 108 and mobile device 120, including but not limited to Bluetooth, Wi-Fi, and Infra-red (IR).

In the embodiment illustrated in FIG. 3A, mobile device 120 communicates the received information to mobile backend server 104 (message 304). In one embodiment, the information conveyed to mobile backend server 104 may include some or all of the information transmitted in message 302, and may additionally include information such as information identifying the user of mobile device 120 (e.g., a user ID, a device ID, etc.), information identifying the location of mobile device 120 (e.g., GPS coordinates, location based services (LBS) information, etc.), and so on.

In the embodiment illustrated in FIG. 3A, mobile backend server 104 receives the information and connects to the point of interaction 108. For simplicity, this interaction, which may include a series of messages/handshakes/authentications, etc., is shown as double arrow 306.

In the embodiment illustrated in FIG. 3A, point of interaction 108 sends to mobile backend server 104 transaction information (message 308). Examples of transaction information include, but are not limited to, a transaction amount (summary or detailed), details about items purchased, a merchant class code (MCC), a location, a time and/or date, user ID, and device ID, to name a few.

At block 310, mobile backend server 104 uses the received information to determine who is attempting to perform the requested transaction and to determine what accounts are available to that person or entity. At block 312, mobile backend server 104 fetches the preferences associated with the identified user and/or account(s).

In the embodiment illustrated in FIG. 3A, mobile backend server 104 may fetch or determine information related to account activity. Such metrics may include, but are not limited to, the total amount of transactions that have already been completed in a specified period (day, week, month, year, total to date, etc.), a current credit limit/credit balance, a current debit limit/debit balance, a current amount available on a prepaid account, and so on.

It is noted that some preferences may define spending thresholds, purchasing limits, or other rules that vary based on such metrics, while other preferences may not. For example, a preference may limit User B's purchases to some amount per month. Another preference may restrict User B from ever purchasing alcohol. The former preference considers account activity metrics, while the latter does not.

At block 316, mobile backend server 104 applies the preferences (and account activity metrics, if needed), to make a decision whether to allow or deny the transaction. If the transaction is denied or declined, mobile backend server 104 may notify point of interaction 108, the user (e.g., via mobile device 120), another party, such as an administrator or other person that controls the preferences, a financial institution, a credit reporting agency, a law enforcement agency, a fraud investigation agency, or other entity that may desire notification of a failed attempt to perform a transaction, and the process would likely end. In the embodiment illustrated in FIG. 3A, however, the transaction is allowed, and User B is notified of this fact (message 318) via his mobile device 120. The process continues in FIG. 3B.

FIG. 3B is a signaling messaging diagram illustrating additional messages communicated among components of an exemplary system for providing an entity with the ability to control behaviors and capabilities of the entity's accounts and/or account transactions on a per-user basis according to an embodiment of the subject matter described herein.

In the embodiment illustrated in FIG. 3B, User B has been notified that the desired transaction has been approved. In one embodiment, the user is prompted to confirm that the transaction should, in fact, proceed. In one embodiment, the user may be prompted to provide authentication information, such as a password, passphrase, PIN, or other form of authentication (including biometric authentication) as part of the approval process (block 320).

In the embodiment illustrated in FIG. 3B, User B approves the transaction and is successfully authenticated, and mobile device 120 notifies mobile backend server 104 of this fact (message 322). Mobile backend server generates payment information (block 324). Examples of payment information include, but are not limited to, account number, account name, issuing authority, merchant identity, or any other information needed to perform the desired transaction. Payment information may include some or all of transaction information 308.

In one embodiment, mobile backend server 104 may send the payment information directly to payment transaction network 106 (message 326). Alternatively, mobile backend server 104 may send payment information to the point of interaction 108 (message 328), which may or may not preprocess the information before sending it to payment transaction network 106 (message 330).

Regardless of how the payment information gets to payment transaction network 106, in the embodiment illustrated in FIG. 3B, payment transaction network 106 initiates the payment transaction (block 332), and reports the result of the attempted transaction back to mobile backend server 104, point of interaction 108, and/or mobile device 120 (message 334).

In one embodiment, account preferences and payment information may be stored on the same database. Alternatively, account preferences may be stored on a database that is separate from where payment information is stored. In one embodiment, for example, payment information may be stored in a more tightly secured database than the database used to store preferences. Because a “preferences-only” database would not store sensitive payment information, it may be safely shared among multiple mobile backend servers, for example, while each mobile backend server may contain its own internal, highly protected and tightly secured payment database.

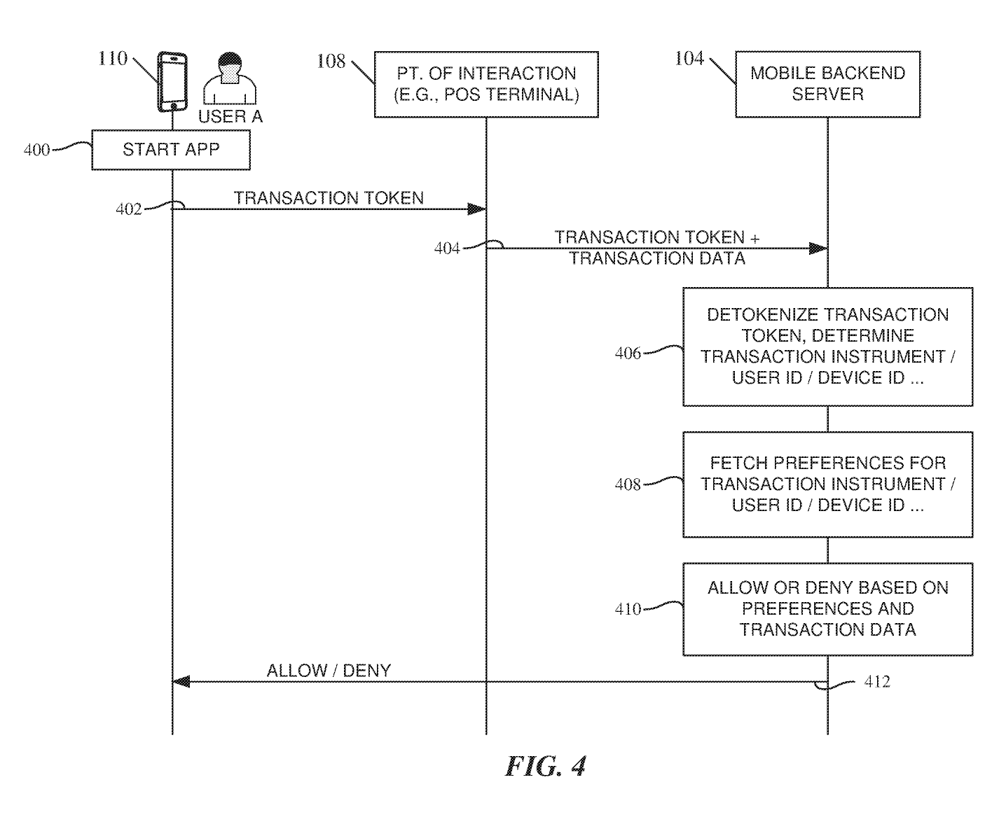

FIG. 4 is a signaling messaging diagram illustrating messages communicated among components of an exemplary system for providing an entity with the ability to control behaviors and capabilities of the entity's accounts and/or account transactions on a per-user basis according to an embodiment of the subject matter described herein.

The process may start at the time of any transaction. In the embodiment illustrated in FIG. 4, the process is triggered by an attempt, by a user (“User A”) to use a smartphone or other mobile device 110 to perform an electronic transaction, but the process may be triggered by other types of transactions, including but not limited to, an attempt by a user to use a provided credit or debit card, for example.

In the embodiment illustrated in FIG. 4, at step 400, User A may start a payment application (or other type of application) on his mobile device 110 which will effect the transaction. Mobile device 110 sends to point of interaction 108 a transaction token (message 402) that represents aspects of the transaction. In one embodiment, point of interaction 108 sends the transaction token, along with additional transaction data, to mobile backend server 104 (message 404). Upon receiving the transaction token, mobile backend server 104 detokenizes it (block 406) and uses the extracted data to ultimately determine payment information, which may be stored in the secure backend.

In one embodiment, the token itself contains the information associated with the transaction, in which case the token may be decoded, decrypted, uncompressed, and so on, in order to extract from the token the transaction information. In another embodiment, the token does not contain the information associated with the transaction but instead identifies or represents an object that does contain the information associated with the transaction. In these cases, the token is used to find the object containing the desired transaction information. For example, the token could contain an index into a table or database that stores information for transactions. The index extracted from the token could be used to retrieve the transaction information from that table or database.

In one embodiment, the transaction token may directly represent payment data, such as credit card data or debit card data. For example, the token may include or represent a cardholder name, primary account, expiration date, security code, or other information typically present on those forms of transaction instruments. Alternatively, the transaction token may indirectly represent payment data. For example, the transaction token may include or represent information identifying a user (e.g., “User A”) or a user device (e.g., a device ID that identifies User A's mobile device 110). The transaction token may include or represent information that identifies a transaction type (e.g., “use my credit card” or “use my debit card”) but does not include card number, account number, or other payment data. In either case, however, the information represented by the transaction token may be used to ultimately determine payment data.

In the embodiment illustrated in FIG. 4, mobile backend server fetches the preferences associated with the information represented by the token (block 408), and uses the preference information and the transaction data to determine whether to allow or deny the transaction (block 410). In the embodiment illustrated in FIG. 4, User A is notified whether the transaction is allowed or denied (message 412). If allowed, in one embodiment the process may go through the steps of user approval/authentication, generation of payment information, initiation of payment transaction, and reporting the result in a manner similar to that shown in FIG. 3B, but other processes are also contemplated.

### Example Use Cases

The following use cases are intended to illustrate the flexibility and adaptability of the subject matter described herein to a wide variety of need scenarios and are not intended to be limiting.

Home/Family Use.

In one embodiment, a system for providing an entity with the ability to control behaviors and capabilities of the entity's accounts and/or account transactions on a per-user basis operates to allow the entity—which in this scenario is a head of household, for example—to control which members of the family have access to family finances and what each member can and cannot do. In one example scenario, a husband and wife share a bank account (e.g., the account bears both of their names), but each has a credit card with just their name on it. Using the terminology described above, the roles of each member of the family are described in Table 1, below (in no particular order):

TABLE 1

| Member of household | Role |
|---|---|
| Husband | Owner, Full Admin, User |
| Wife | Owner, Full Admin, User |
| Adult child, Spouse, etc. | Limited Admin, User |
| Responsible minor child | Privileged User |
| Irresponsible minor child | User |
| Young child | Limited user |

In this example, both the husband and wife are owners since the accounts to which the financial instruments (credit cards, debit cards, prepaid cards, etc.) are associated are in both of their names. Both husband and wife have the ability to set rules and limits for themselves and for the other members of the family, i.e., they have full admin privileges. Both husband and wife are users, i.e., they have and use payment instruments tied to the account.

In this example, the family includes four children. The first is an adult child who is a user with limited admin privileges, i.e., the ability to set rules and limits for other members of the family except for the parents, who, as full administrators have a higher privilege level than the children. The second is a minor child who has demonstrated some financial or fiscal responsibility and thus has been granted “privileged user” status, i.e., the ability to set up rules and limits for himself or herself. The third is a minor child who has not demonstrated the requisite financial or fiscal responsibility and thus has not been granted privileged user status but nevertheless has access to a credit or debit card. The fourth is a young child who is too young to have access to a credit or debit card. Referring back to FIG. 1, for example, User A might represent a parent and User B might represent one of the children who are allowed to have a credit or debit card.

In this example, the following rules and limits might be defined for each member of the family. Although this example is a bit whimsical, it illustrates the range of capabilities possible using systems and methods described herein.

TABLE 2

| Member of | |
|---|---|
| household | Example rules and limits applied to that member. |
| Spouse | Deny purchases from liquor stores, but allow |
| (Husband) | purchases from other types of stores; deny all |
| | access to all payment instruments if “location = |
| | Las Vegas, Nevada”. |
| Spouse | If purchase amount <$500, use debit card; |
| (Wife) | else use credit card. |
| Adult child | Apply monthly transaction limit. Provide |
| | monthly report to parents. |
| Responsible | Allow purchases from debit card but not from |
| minor child | credit card; apply individual transaction |
| | limit; apply monthly transaction limit. |
| | Provide monthly report to parents. |
| Irresponsible | Deny purchases of any item except for food; |
| minor child | apply individual transaction, monthly, and |
| | yearly limits. Provide weekly report to |
| | parents. Immediately notify parents of |
| | attempts to purchase non-food items. |
| Young child | Allows transactions at child school cafeteria |
| | only up to a certain transaction amount limit |
| Other/general | Immediately notify full administrator(s) |
| | of any of the following events: |
| | Any modification of rules and limits by any |
| | admin or privileged user; |
| | Any attempt to make disallowed purchases; |
| | Any allowed purchase made outside of a specified |
| | geographical area; |
| | That allowed purchases are approaching or have |
| | reached a transaction limit; or |
| | That the irresponsible minor child has tried to |
| | purchase cigarettes again, that weasel*. |

*We all have known someone like this. Don't pretend you don't know what I'm talking about.

Other examples include, but are not limited to:
Defining a particular payment instrument to be a default when the user is at a particular store or merchant, when the user is using a particular ecommerce site, or when the user is using a particular merchant's mobile application.
When a default instrument has been defined, either (a) always asking the user to confirm that the default instrument should be used, (b) never asking the user to confirm that the default instrument should be used, or (c) asking the user to confirm that the default instrument should be used only under certain conditions.
Giving the user the ability to turn off a default instrument. For example, some services ask for a credit card number so that they can charge a recurring (e.g., monthly) fee, but make it nearly impossible for the user to figure out how to STOP paying that monthly fee or change the payment instrument. The systems and methods described herein make it easy for the user to do these things.
Defining credit limits for credit cards and funding limits for debit or prepaid cards (e.g., separate from the credit or funding limits imposed by the issuing authority.)

Of particular interest in the home scenario, but also applicable to other scenarios, is the ability to configure a payment instrument to have certain limits, rules, or other controls on behaviors and capabilities before sending that payment instrument to another person (or otherwise making that payment instrument available to the other person.)

Corporate Use.

In another embodiment, a system for providing an entity with the ability to control behaviors and capabilities of the entity's accounts and/or account transactions on a per-user basis operates to allow the entity—which in this scenario is a corporation or other business entity, for example—to control which employees have access to corporate accounts.

TABLE 3

| Employee | Role | Comments/Example rules and limits |
|---|---|---|
| Corporate | Owner | The name on the account, but not an |
| entity | | actual user. |
| CEO | User | The CEO can use the card, but has |
| | | delegated the creation of the rules |
| | | and limits to the CFO, i.e., the |
| | | CEO is not an admin. |
| CFO | Full Admin, | Responsible for setting rules and |
| | User | limits for the entire company, and |
| | | occasionally uses the card. |
| Department | Limited | The CFO has established department |
| Head(s) | Admin | limits, but each department head |
| | | can define additional limits for |
| | | department employees. Department |
| | | heads are not users, but instead |
| | | authorize purchasing agents and |
| | | staff to make purchases. |
| Purchasing | Limited Admin, | A person authorized to spend money |
| agent | User | from the department budget; can also |
| | | define additional limits for staff. |
| Staff | Privileged | Can make purchases subject to limits |
| | User | imposed by the CFO, the department |
| | | head, and the purchasing agent. |
| | | Can additionally impose limits on |
| | | self (including setting up notifications) |
| | | to help stay within budget. |

In the corporate example described in Table 3, above, all accounts are in the name of the corporate entity, and therefore the corporate entity is the owner. However, the corporate entity does not make any actual purchases—some of the employees do—so the corporate entity is not a user. In this example, the CEO has delegated administrative responsibility to the CFO, but occasionally uses the card to wine and dine clients and potential clients; the CEO is therefore a user but not an administrator. The CFO is the full administrator, and sets up rules and policies for the entire corporate entity.

In the example above, each department head must work within a department budget limit set by the CFO but has flexibility to decide how that money is to be allocated and therefore have limited admin privileges. In this hypothetical company the department heads are not users but instead delegate that responsibility to one or more purchasing agents, who are employees with authority to spend money from the department budget. The purchasing agents are also limited admins who can set limits for particular staff members. The authorized staff members are privileged (or non-privileged) users who have authority to use the company credit or debit card to make purchases on behalf of their department(s).

For example, a department head may be notified by the CFO that his or her department has a yearly budget amount of <X> dollars, for example. The department head may decide that some portion of that may be spent on office supplies, another portion may be spent on monthly or yearly software license renewals, yet another portion may be spent on rent, utilities, and so on. The department head may inform the purchasing agent of these budget categories and limits of each category. The purchasing agent may then authorize particular staff members to be responsible for particular portions of the budget. For example, one staff member may be authorized to pay for software licenses, software or hardware upgrades or repairs, and so on, while another staff member may be responsible for maintaining office supplies levels.

By setting up these rules and limits at the beginning of each budget term, including notification triggers, the systems and methods described herein can provide the kind of structure, limits, and feedback to help a corporate entity stay within budget limits while receiving early warning or notifications of potential cost overruns. These notifications allow the corporate entity to be nimble enough to deal with changes that inevitably occur in the corporate landscape.

General Use.

In yet another embodiment, a system for providing an entity with the ability to control behaviors and capabilities of the entity's accounts and/or account transactions on a per-user basis operates to allow the entity to enable or disable all account activity for a transaction instrument using a single command or via a single interface. This is particularly useful in scenarios where a single credit card, for example, is being used for a number of monthly subscriptions. Rather than having to contact each of the entities (assuming that the user can even remember all of them) and making individual requests to terminate the monthly subscriptions, the systems and methods described herein allow the user to simply disable the entire credit card, which will cause all subsequent attempts to charge monthly subscription fees to the credit card to fail. This function could be thought of as “a global on/off switch” for card activity.

The same mechanism may be used to temporarily suspend activity rather than terminate it permanently. In embodiments where the system includes a user interface that the user may use to set up the various rules and preferences, the user may be presented with a central list of cards, accounts, and/or recurring or non-recurring charges, etc., and may be allowed to selectively enable or disable them individually. In this manner a user is able to block all use of a particular card, block all transactions with a particular party regardless of card, and so on.

This is also useful for a user who often travels: the user may selectively enable or disable various transaction instruments according to need. For example, a person traveling to a different country may decide to disable all cards except a few that he or she plans to use while in the foreign country. In this manner, activity on the disabled cards is barred, which protects the traveler in case the cards are stolen while he is traveling (if he took the cards with him) and also in case the cards are used without the user's knowledge or permission by someone back in the home country (if he left the cards at home). Once the traveler returns, he may use the system to reactivate the deactivated or suspended transaction instruments.

In summary, the systems and methods described herein allow an entity (who might also be a user) to set rules and limits for a payment instrument on a per-user basis. A user may define different limits for himself or herself and may also define limits for another user. Limits may be set for each account, for each sub-account, for each user of an account or sub-account, for classes of users, and for a particular user or class of user across multiple accounts. Limits may be set based on account type, merchant or merchant class, purchased item or item class, amount, time of day, day of week, geographic location, and so on. Rules may define restrictions on financial transactions but may also define “if/then/else” conditions that can direct the transaction to use one payment instrument under certain conditions and another payment instrument under other conditions. Rules can even split transactions across multiple instruments, such as “charge the first X amount to payment instrument A and any remainder over X amount to payment instrument B”.

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

### Embodiment 1

A system for providing an entity with the ability to control behaviors and capabilities of the entity's accounts and/or account transactions on a per-user basis, the system comprising: a database for associating an entity with at least one account and for storing entity-defined and user-defined preferences that control behaviors and capabilities of the entity's accounts and/or account transactions on a per-user basis; and a mobile backend server that operates as a conduit or intermediary for the entity's electronic financial or non-financial transactions and that applies to the transactions the preferences that control behaviors and capabilities of the entity's accounts and/or account transactions on a per-user basis.

### Embodiment 2

The system of embodiment 1 wherein the transaction or account information includes at least one of: an account name, an account number, an account issuing bank, a user or entity name, a user or entity physical address, a user or entity shipping address, identification information for identifying a user, and authentication information for authenticating a user.

### Embodiment 3

The system of embodiment 1 wherein a transaction comprises: a payment or purchase; a credit transaction; a debit transaction; a prepaid transaction; a deposit; a withdrawal; a money transfer; bill payment; a transaction involving a loyalty program; a transaction involving a rewards program; or a transaction involving a diet, health, or fitness program.

### Embodiment 4

The system of embodiment 1 wherein an account comprises a card payment account or a non-card, cardless, or virtual card account.

### Embodiment 5

The system of embodiment 1 wherein an account comprises: a payment account; a credit, debit, or prepaid account; a branded account; a retailer or private label account; a gift or gift card account; or a checking or savings account.

### Embodiment 6

The system of embodiment 1 wherein an account comprises: a loyalty account; a healthcare or wellness account; an access account; a membership account; or a rewards account.

### Embodiment 7

The system of embodiment 1 wherein applying preferences to the transactions includes: receiving information associated with a desired transaction; determining a user associated with the desired transaction; determining an entity account associated with the user; determining a preference for the desired transaction, for the entity account, or both; and applying the preference to control a behavior and/or a capability of the entity accounts and/or account transactions on a per-user basis.

### Embodiment 8

The system of embodiment 7 wherein applying preferences to the transactions further includes determining an account activity metric and wherein applying the preference to control a behavior and/or a capability includes considering the account activity metric.

### Embodiment 9

The system of embodiment 7 wherein the information associated with the desired transaction includes information about at least one of: a type of the transaction; an amount of the transaction; a party to the transaction; a time of the transaction; a location of the transaction; and a good, service, or subject of the transaction.

### Embodiment 10

The system of embodiment 7 wherein the mobile backend server receives the information associated with a desired transaction from a mobile device of the user.

### Embodiment 11

The system of embodiment 10 wherein the mobile device of the user receives the information associated with the desired transaction from at least one of: a user of the mobile device; a point of sale terminal; an ecommerce website; and the mobile backend server.

### Embodiment 12

The system of embodiment 10 wherein the mobile device of the user receives the information associated with the desired transaction via scanning and decoding a QR code that encodes at least some of the information.

### Embodiment 13

The system of embodiment 10 wherein the mobile device of the user receives the information associated with the desired transaction via NFC, Bluetooth, or WiFi.

### Embodiment 14

The system of embodiment 1 wherein the transactions comprise at least one of: transactions made using a physical point of sale terminal; transactions made online or via an ecommerce website; and transactions made using a mobile device or mobile application.

### Embodiment 15

The system of embodiment 1 wherein the preferences that control behaviors and capabilities of the entity's accounts and/or account transactions on a per-user basis include a preference related to an account.

### Embodiment 16

The system of embodiment 15 wherein the preference related to an account includes at least one of: an active/enabled or inactive/disabled state of the account; a restriction on use of the account involving a user or class of users; a restriction on use of the account involving a merchant or class of merchants; a restriction on a transaction involving an ecommerce site or class of ecommerce sites; a restriction on a transaction involving a point of sale terminal or class of point of sale terminals; a restriction on use of the account for a good or class of goods; a restriction on use of the account for a service or class of services; a temporal restriction on use of the account; a geographical restriction on use of the account; a restriction on a class of accounts; a restriction on an amount or range of amounts allowed per transaction; a restriction on an amount or range of amounts allowed per a period of time; a restriction on a type of device used to perform the transaction; an ability to transfer funds to or from the account; an ability to transfer control of the account; an ability to create a sub-account; an ability of the account to be shared by multiple users; and any combination of the above.

### Embodiment 17

The system of embodiment 1 wherein the preferences that control behaviors and capabilities of the entity's accounts and/or account transactions on a per-user basis include a preference related to a transaction.

### Embodiment 18

The system of embodiment 1 wherein the preference related to a transaction includes at least one of: a restriction on a type of transaction; a restriction on a transaction involving a user or class of users; a restriction on a transaction involving a merchant or class of merchants; a restriction on a transaction involving an ecommerce site or class of ecommerce sites; a restriction on a transaction involving a point of sale terminal or class of point of sale terminals; a restriction on a transaction for a good or class of goods; a restriction on a transaction for a service or class of services; a temporal restriction on transactions; a geographical restriction on transactions; a restriction on a transaction for an amount limit or range of amounts; a restriction on a type of device used to perform the transaction; a restriction on a transaction's recurrence; and any combination of the above.

### Embodiment 19

The system of embodiment 1 wherein the application of a preference that controls behaviors and capabilities of the entity's accounts and/or account transactions on a per-user basis include an application of a user preference.

### Embodiment 20

The system of embodiment 19 wherein application of a user preference includes at least one of: imposition of a user's favored preference; prohibition of a user's disfavored preference; selection of a user's most favored preference of those available for a particular transaction; and selection of a user's most favored preference of those available for a particular account.

### Embodiment 21

The system of embodiment 19 wherein application of a user preference includes enabling or disabling an account, a transaction instrument, or a combination of the above.

### Embodiment 22

The system of embodiment 1 wherein a preference includes at least one of: a shipping preference; a level or type of authentication to be required for the transaction or account; a level of type authorization to be required for the transaction or account; and a level of type notification of the occurrence of a transaction or account.

### Embodiment 23

The system of embodiment 1 wherein the preferences that control behaviors and capabilities of the entity's accounts and/or account transactions on a per-user basis include a preference related to a condition.

### Embodiment 24

The system of embodiment 23 wherein a preference related to a condition includes: a preference related to a condition of the transaction; a preference related to a condition of the account; a preference related to a condition of the user; or any combination of the above.

### Embodiment 25

A method for providing an entity with the ability to control behaviors and capabilities of the entity's accounts and/or account transactions on a per-user basis, the method comprising: associating an entity with transaction or account information and storing entity-defined and user-defined preferences that control behaviors and capabilities of the entity's accounts and/or account transactions on a per-user basis; and providing a mobile backend server that operates as a conduit or intermediary for a user's electronic financial or non-financial transactions and that applies to the transactions the preferences that control behaviors and capabilities of the entity's accounts and/or account transactions on a per-user basis.

### Embodiment 26

The method of embodiment 25 wherein the transaction or account information includes at least one of: an account name, an account number, an account issuing bank, a user or entity name, a user or entity physical address, a user or entity shipping address, identification information for identifying a user, and authentication information for authenticating a user.

### Embodiment 27

The method of embodiment 25 wherein a transaction comprises: a payment or purchase; a credit transaction; a debit transaction; a prepaid transaction; a deposit; a withdrawal; a money transfer; a bill payment; a transaction involving a loyalty program; a transaction involving a rewards program; or a transaction involving a diet, health, or fitness program.

### Embodiment 28

The method of embodiment 25 wherein an account comprises a card payment account or a non-card, cardless, or virtual card account.

### Embodiment 29

The method of embodiment 25 wherein an account comprises: a payment account; a credit, debit, or prepaid account; a branded account; a retailer or private label account; a gift or gift card account; a checking account; or a savings account.

### Embodiment 30

The method of embodiment 25 wherein an account comprises: a loyalty account; a healthcare or wellness account; an access account; a membership account; or a rewards account.

### Embodiment 31

The method of embodiment 25 wherein applying preferences to the transactions includes: receiving information associated with a desired transaction; determining a user associated with the desired transaction; determining an entity account associated with the user; determining a preference for the desired transaction, for the entity account, or both; and applying the preference to control a behavior and/or a capability of the entity accounts and/or account transactions on a per-user basis.

### Embodiment 32

The method of embodiment 31 wherein receiving information associated with a desired transaction includes receiving a transaction token that represents a desired transaction and detokenizing the transaction token to extract the information associated with the desired transaction.

### Embodiment 33

The method of embodiment 31 wherein applying preferences to the transactions further includes determining an account activity metric and wherein applying the preference to control a behavior and/or a capability includes considering the account activity metric.

### Embodiment 34

The method of embodiment 31 wherein the information associated with the desired transaction includes information about at least one of: a type of the transaction; an amount of the transaction; a party to the transaction; a time of the transaction; a location of the transaction; and a good, service, or subject of the transaction.

### Embodiment 35

The method of embodiment 31 wherein the mobile backend server receives the information associated with a desired transaction from a mobile device of the user.

### Embodiment 36

The method of embodiment 35 wherein the mobile device of the user receives the information associated with the desired transaction from at least one of: a user of the mobile device; a point of sale terminal; an ecommerce website; and the mobile backend server.

### Embodiment 37

The method of embodiment 35 wherein the mobile device of the user receives the information associated with the desired transaction via scanning and decoding a QR code that encodes at least some of the information.

### Embodiment 38

The method of embodiment 35 wherein the mobile device of the user receives the information associated with the desired transaction via NFC, Bluetooth, or WiFi.

### Embodiment 39

The method of embodiment 25 wherein the transactions comprise at least one of: transactions made using a physical point of sale terminal; transactions made online or via an ecommerce website; and transactions made using a mobile device or mobile application.

### Embodiment 40

The method of embodiment 25 wherein the preferences that control behaviors and capabilities of the entity's accounts and/or account transactions on a per-user basis include a preference related to an account.

### Embodiment 41

The method of embodiment 40 wherein the preference related to an account includes at least one of: an active/enabled or inactive/disabled state of the account; a restriction on use of the account involving a user or class of users; a restriction on use of the account involving a merchant or class of merchants; a restriction on a transaction involving an ecommerce site or class of ecommerce sites; a restriction on a transaction involving a point of sale terminal or class of point of sale terminals; a restriction on use of the account for a good or class of goods; a restriction on use of the account for a service or class of services; a temporal restriction on use of the account; a geographical restriction on use of the account; a restriction on a class of accounts; a restriction on an amount or range of amounts allowed per transaction; a restriction on an amount or range of amounts allowed per a period of time; a restriction on a type of device used to perform the transaction; an ability to transfer funds to or from the account; an ability to transfer control of the account; an ability to create a sub-account; an ability of the account to be shared by multiple users; and any combination of the above.

### Embodiment 42

The method of embodiment 25 wherein the preferences that control behaviors and capabilities of the entity's accounts and/or account transactions on a per-user basis include a preference related to a transaction.

### Embodiment 43

The method of embodiment 25 wherein the preference related to a transaction includes at least one of: a restriction on a type of transaction; a restriction on a transaction involving a user or class of users; a restriction on a transaction involving a merchant or class of merchants; a restriction on a transaction involving an ecommerce site or class of ecommerce sites; a restriction on a transaction involving a point of sale terminal or class of point of sale terminals; a restriction on a transaction for a good or class of goods; a restriction on a transaction for a service or class of services; a temporal restriction on transactions; a geographical restriction on transactions; a restriction on a transaction for an amount limit or range of amounts; a restriction on a type of device used to perform the transaction; a restriction on a transaction's recurrence; and any combination of the above.

### Embodiment 44

The method of embodiment 25 wherein applying preferences that control behaviors and capabilities of the entity's accounts and/or account transactions on a per-user basis include applying a user preference.

### Embodiment 45

The method of embodiment 44 wherein applying a user preference includes at least one of: imposition of a user's favored preference; prohibition of a user's disfavored preference; selection of a user's most favored preference of those available for a particular transaction; and selection of a user's most favored preference of those available for a particular account.

### Embodiment 46

The method of embodiment 25 wherein applying a user preference includes enabling or disabling an account, a transaction instrument, or a combination of the above.

### Embodiment 47

The method of embodiment 25 wherein a preference includes at least one of: a shipping preference; a level or type of authentication to be required for the transaction or account; a level of type authorization to be required for the transaction or account; and a level of type notification of the occurrence of a transaction or account.

### Embodiment 48

The method of embodiment 25 wherein the preferences that control behaviors and capabilities of the entity's accounts and/or account transactions on a per-user basis include a preference related to a condition.

### Embodiment 49

The method of embodiment 48 wherein a preference related to a condition includes: a preference related to a condition of the transaction; a preference related to a condition of the account; a preference related to a condition of the user; or any combination of the above.

### Embodiment 50

A non-transitory computer readable medium having stored thereon computer executable instructions that when executed by a processor of a computer control the computer to perform steps comprising: at a mobile backend server: associating an entity with transaction or account information and storing entity-defined and user-defined preferences that control behaviors and capabilities of the entity's accounts and/or account transactions on a per-user basis; and providing a mobile backend server that operates as a conduit or intermediary for a user's electronic financial or non-financial transactions and that applies to the transactions the preferences that control behaviors and capabilities of the entity's accounts and/or account transactions on a per-user basis.

1. A system for providing an entity with an ability to control behaviors and capabilities of accounts and/or account transactions of the entity on a per-user basis, the system comprising:
a database for associating an entity with an account and for storing entity-defined and user-defined preferences that control behaviors and capabilities of the account on a per-user basis; and
a mobile backend server that operates as a conduit or intermediary for electronic financial or non-financial transactions of the entity and that applies to the transactions at least one preference that controls behaviors and capabilities of the account on a per-user basis prior to processing by a payment transaction network.

2. (canceled)

3. The system of claim 1 wherein the account comprises at least one of:
a card payment account;
a payment account;
a credit, debit, or prepaid account;
a branded account;
a retailer or private label account;
a gift or gift card account;
a checking or savings account;
a loyalty account;
a healthcare or wellness account;
an access account;
a membership account;
a rewards account; or
a non-card, cardless, or virtual card account.

4. (canceled)

5. (canceled)

6. The system of claim 1 wherein the preferences that control behaviors and capabilities of the account control a transaction involving the account, wherein the transaction comprises at least one of: a payment or purchase; a credit transaction; a debit transaction; a prepaid transaction; a deposit; a withdrawal; a money transfer; a bill payment; a transaction involving a loyalty program; a transaction involving a rewards program; or a transaction involving a diet, health, or fitness program.

7. (canceled)

8. The system of claim 1 wherein applying the at least one preference to the transactions includes:
receiving information associated with a desired transaction;
determining a user associated with the desired transaction;
determining an entity account associated with the user;
determining at least one preference for the desired transaction, for the entity account, or both; and
applying the at least one preference to control the behavior and/or capability of the account on a per-user basis.

9. The system of claim 8 wherein applying the at least one preference to the transactions further includes determining an account activity metric and wherein applying the at least one preference to control the behavior and/or capability includes considering the account activity metric.

10. (canceled)

11. The system of claim 8 wherein the mobile backend server receives the information associated with a desired transaction from a mobile device of the user and wherein the mobile device of the user receives the information associated with the desired transaction from at least one of: a user of the mobile device; a point of sale terminal; an ecommerce website; or the mobile backend server.

12-14. (canceled)

15. The system of claim 1 wherein the transactions comprise at least one of: a transaction made using a physical point of sale terminal; a transaction made online or via an ecommerce website; or a transaction made using a mobile device or mobile application.

16. The system of claim 1 wherein the preferences that control the behaviors and capabilities of the account on a per-user basis include a preference related to the account.

17. The system of claim 16 wherein the preference related to the account includes at least one of:
an active/enabled or inactive/disabled state of the account;
restriction on use of the account involving a user or class of users;
a restriction on use of the account involving a merchant or class of merchants;
a restriction on a transaction involving an ecommerce site or class of ecommerce sites;
a restriction on a transaction involving a point of sale terminal or class of point of sale terminals;
a restriction on use of the account for a good or class of goods;
a restriction on use of the account for a service or class of services;
a temporal restriction on use of the account;
a geographical restriction on use of the account;
a restriction on a class of the account;
a restriction on an amount or range of amounts allowed per transaction;
a restriction on an amount or range of amounts allowed per a period of time;
a restriction on a type of device used to perform the transaction;
an ability to transfer funds to or from the account;
an ability to transfer control of the account;
an ability to create a sub-account; or
an ability of the account to be shared by multiple users.

18. The system of claim 1 wherein the preferences that control the behaviors and capabilities of the entity's accounts on a per-user basis include a preference related to a transaction involving the account.

19. The system of claim 1 wherein the preference related to a transaction includes at least one of:
a restriction on a type of transaction;
a restriction on a transaction involving a user or class of users;
a restriction on a transaction involving a merchant or class of merchants;
a restriction on a transaction involving an ecommerce site or class of ecommerce sites;
a restriction on a transaction involving a point of sale terminal or class of point of sale terminals;
a restriction on a transaction for a good or class of goods;
a restriction on a transaction for a service or class of services;
a temporal restriction on transactions;
a geographical restriction on transactions;
a restriction on a transaction for an amount limit or range of amounts;
a restriction on a type of device used to perform the transaction; or
a restriction on recurrence of the transaction.

20. The system of claim 1 wherein the application of the at least one preference that controls the behaviors and capabilities of the account on a per-user basis include an application of a user preference.

21. The system of claim 20 wherein the application of the user preference includes at least one of: imposition of a favored preference of the user; prohibition of a disfavored preference of the user; selection of a most favored preference of the user of those available for a particular transaction; selection of a most favored preference of the user of those available for a particular account; enabling or disabling an account and/or transaction instrument; application of a shipping preference; application of a level or type of authentication to be required for the transaction or account; application of a level of type authorization to be required for the transaction or account; or application of a level of type notification of the occurrence of a transaction or account.

22. (canceled)

23. (canceled)

24. The system of claim 1 wherein the preferences that control the behaviors and capabilities of the account on a per-user basis include a preference related to a condition of the transaction; a preference related to a condition of the account; or a preference related to a condition of a user.

25. (canceled)

26. A method for providing an entity with an ability to control behaviors and capabilities of accounts and/or account transactions of the entity on a per-user basis, the method comprising:
associating an entity with an account and storing entity-defined and user-defined preferences that control the behaviors and capabilities of the account on a per-user basis; and
at a mobile backend server that operates as a conduit or intermediary for electronic financial or non-financial transactions of a user, applying to the transactions at least one preference that controls behaviors and capabilities of the account on a per-user basis prior to processing by a payment transaction network.

27. (canceled)

28. The method of claim 26 wherein the account comprises at least one of:
a card payment account;
a payment account;
a credit, debit, or prepaid account;
a branded account;
a retailer or private label account;
a gift or gift card account;
a checking or savings account;
a loyalty account;
a healthcare or wellness account;
an access account;
a membership account;
a rewards account; or
a non-card, cardless, or virtual card account.

29. (canceled)

30. (canceled)

31. The method of claim 26 wherein applying the at least one preference that controls behaviors and capabilities of the account comprises controlling a transaction involving the account, wherein the transaction comprises at least one of: a payment or purchase; a credit transaction; a debit transaction; a prepaid transaction; a deposit; a withdrawal; a money transfer; a bill payment; a transaction involving a loyalty program; a transaction involving a rewards program; or a transaction involving a diet, health, or fitness program.

32. (canceled)

33. The method of claim 26 wherein applying the at least one preference to the transactions includes:
receiving information associated with a desired transaction;
determining a user associated with the desired transaction;
determining an entity account associated with the user;
determining at least one preference for the desired transaction, for the entity account or both; and
applying the at least one preference to control a behavior and/or a capability of the account on a per-user basis.

34. (canceled)

35. The method of claim 33 wherein applying the at least one preference to the transactions further includes determining an account activity metric and wherein applying the preference to control a behavior and/or a capability includes considering the account activity metric.

36. (canceled)

37. The method of claim 33 wherein the mobile backend server receives the information associated with the desired transaction from a mobile device of the user and wherein the mobile device of the user receives the information associated with the desired transaction from at least one of: a user of the mobile device; a point of sale terminal; an ecommerce website; or the mobile backend server.

38-40. (canceled)

41. The method of claim 26 wherein the transactions comprise at least one of: a transaction made using a physical point of sale terminal; a transaction made online or via an ecommerce website; or a transaction made using a mobile device or mobile application.

42. The method of claim 26 wherein the preferences that control the behaviors and capabilities of the account on a per-user basis include a preference related to the account.

43. (canceled)

44. The method of claim 26 wherein the preferences that control the behaviors and capabilities of the entity's accounts and/or account transactions on a per-user basis include a preference related to a transaction involving the account.

45. (canceled)

46. The method of claim 26 wherein applying the at least one preference that controls the behaviors and capabilities of the entity's accounts and/or account transactions on a per-user basis include applying a user preference.

47-49. (canceled)

50. The method of claim 26 wherein the preferences that control behaviors and capabilities of the entity's accounts and/or account transactions on a per-user basis include a preference related to a condition of the transaction; a preference related to a condition of the account; or a preference related to a condition of the user.

51. (canceled)

52. A non-transitory computer readable medium having stored thereon computer executable instructions that when executed by a processor of a computer control the computer to perform steps comprising:
at a mobile backend server:
associating an entity with transaction or account information and storing entity-defined and user-defined preferences that control behaviors and capabilities of accounts and/or account transactions of the entity on a per-user basis; and
at a mobile backend server that operates as a conduit or intermediary for electronic financial or non-financial transactions of a user, applying to the transactions at least one preference that controls behaviors and capabilities of the account on a per-user basis prior to processing by a payment transaction network.
